(19) United States
(12) Patent Application Publication
(10) Pub. No.: US 2023/0198044 A1
(43) Pub. Date: Jun. 22, 2023

(54) BATTERY MODULE AND BATTERY PACK INCLUDING THE SAME

(71) Applicant: LG Energy Solution, Ltd., Seoul (KR)

(72) Inventors: Won Kyoung Park, Daejeon (KR); Junyeob Seong, Daejeon (KR); Subin Park, Daejeon (KR)

(21) Appl. No.: 17/924,325

(22) PCT Filed: Feb. 17, 2022
(86) PCT No.: PCT/KR2022/002360

§ 371 Date: Nov. 9, 2022

(30) Foreign Application Priority Data
Feb. 25, 2021 (KR) 10-2021-0025865

(51) Int. Cl. H01M 10/647; H01M 50/507; H01M 10/6551; H01M 50/211; H01M 10/653; H01M 50/414

(52) U.S. Cl. CPC H01M 10/647; H01M 50/507; H01M 10/6551; H01M 50/211; H01M 10/653; H01M 50/414

(57) ABSTRACT

A battery module including a battery cell stack including a plurality of battery cells, a housing for the battery cell stack, a pair of busbar frames that cover a portion of the battery cell stack exposed from the housing, a pair of busbars, each of which is connected to an electrode lead protruding from the battery cell stack via a first slot formed in the busbar frame, and a a plurality of cooling fins, each of which is located between battery cells adjacent to each other among the plurality of battery cells, wherein the busbar is connected to the cooling fin.

### CROSS-REFERENCE TO RELATED APPLICATIONS

This application is a US national phase of international application No. PCT/KR2022/002360 filed on Feb. 17, 2022, and claims the benefit of Korean Patent Application No. 10-2021-0025865 filed on Feb. 25, 2021, the contents of which are incorporated herein by reference in their entirety.

### TECHNICAL FIELD

The present disclosure relates to a battery module and a battery pack including the same, and more particularly, to a battery module having a novel cooling structure and a battery pack including the same.

### BACKGROUND

Along with the technology development and increased demand for mobile devices, demand for secondary batteries as energy sources has been increasing rapidly. In particular, a secondary battery has attracted considerable attention as an energy source for power-driven devices, such as an electric bicycle, an electric vehicle, and a hybrid electric vehicle, as well as an energy source for mobile devices, such as a mobile phone, a digital camera, a laptop computer and a wearable device.

Small-sized mobile devices use one or several battery cells for each device, whereas medium- or large-sized devices such as vehicles require high power and large capacity.

Therefore, a medium- or large-sized battery module having a plurality of battery cells electrically connected to one another is used.

Since the medium- or large-sized battery module is preferably manufactured to have as small a size and weight as possible, a prismatic battery, a pouch-shaped battery or the like, which can be stacked with high integration and has a small weight relative to capacity, is mainly used as a battery cell of the medium- or large-sized battery module. Such a battery module has a structure in which a plurality of cell assemblies including a plurality of unit battery cells are connected in series to obtain high output. And, the battery cell includes positive electrode and negative electrode current collectors, a separator, an active material, an electrolyte solution, and the like, and thus can be repeatedly charged and discharged by an electrochemical reaction between components.

Meanwhile, along with a continuous rise of the necessity for a large-capacity secondary battery structure, including the utilization of the secondary battery as an energy storage source, there has been a growing demand recently for a battery pack of a multi-module structure, which is an stackstack of battery modules in which a plurality of secondary batteries are connected in series or in parallel.

Meanwhile, when a plurality of battery cells are connected in series or in parallel to configure a battery pack, a common method of manufacturing a battery pack includes first configuring a battery module composed of at least one battery cell and then adding other components to the at least one battery module.

FIG. 1 is a perspective view of a portion of a conventional battery module. FIG. 2 is an enlarged cross-sectional view along the xy plane along the line A-A′ of FIG. 1.

As illustrated in FIGS. 1 and 2, the conventional battery module includes a battery cell stack consisting of a plurality of battery cells 11 stacked on each other, and a busbar stack that electrically connects the electrode leads 12 of the plurality of battery cells 11 to each other, a housing 13 that covers the battery cell stack, and an external frame 14 that covers a busbar assembly. Here, the busbar assembly includes a busbar frame 15 having lead slots that allow the discrete passage of the electrode leads 12 of each battery cell 11, and busbar slots mounted on the busbar frame 15 and provided to correspond to the number of lead slots, and further includes a busbar 16 that is connected to the electrode leads passing through the busbar slots by welding, etc. Further, a pair of cooling fins 17 may be arranged between the battery cells 11 of the battery cell stack.

At this time, the busbar 16 is separated from the respective cooling fin 17 by the busbar frame 15, so that heat generated in the busbar 16 cannot be directly transferred to the cooling fin 17. Instead, the heat generated in the busbar 16 is transferred via the electrode leads 12 to the cooling fin 17, and then transferred via a thermal conductive resin layer formed on the bottom part of the battery cell 11 and the housing 13.

Recently, it has become necessary to continuously increase capacity, energy, charging rate and the amount of current flowing through the busbar. The high current flowing through the busbar generates heat in the busbar, and it is difficult to effectively cool the heat generated through a conventional cooling structure alone. Therefore, there is a need for a structure that can make direct contact with the busbar to cool the busbar.

### DETAILED DESCRIPTION OF THE INVENTION

It is an objective of the present disclosure to provide a battery module that can solve the problem of heat generation of the busbar and a battery pack including the same.

However, the objectives of the present disclosure are not limited to the aforementioned objectives, and other objectives which are not described herein should be clearly understood by those skilled in the art from the following detailed description and the accompanying drawings.

According to one aspect of the present disclosure, there is provided a battery module comprising: a battery cell stack in which a plurality of battery cells are stacked, a housing that houses the battery cell stack, a busbar frame that covers a portion of the battery cell stack that is exposed (not covered by the housing), a busbar that is connected to an electrode lead protruding from the battery cell stack via a first slot formed in the busbar frame, and a cooling fin that is located between battery cells adjacent to each other among the plurality of battery cells, wherein the busbar is connected to the cooling fin.

The battery module may further include a heat transfer member located between the busbar and the cooling fin.

The busbar frame may further include a second slot, and the heat transfer member may be formed adjacent to the second slot to come into contact with the busbar.

The cooling fin may be inserted into the second slot to come into contact with the heat transfer member.

The heat transfer member may be formed of a material having electrical insulating properties and thermal conductivity.

The heat transfer member may be surface-joined with the busbar.

The cooling fin may be surface-joined with the heat transfer member.

The battery module may further include a thermal conductive resin layer located on the bottom part of the housing, wherein the cooling fin may be in contact with the thermal conductive resin layer, and the heat generated from the busbar may be sequentially transferred to the heat transfer member, the cooling fin, and the thermal conductive resin layer.

The housing of the battery module according to another embodiment of the present disclosure may include a structure that covers all side surfaces of the battery cell stack and is open at the top and bottom such that the upper and lower surfaces of the battery cell stack are not covered by the housing.

The battery module may further include a cooling plate located at under the thermal conductive resin layer, wherein the thermal conductive resin layer may come into contact with the cooling plate, and the heat transferred to the thermal conductive resin layer may be transferred to the cooling plate.

According to another embodiment of the present disclosure, there is provided a battery pack comprising the above-mentioned battery module.

According to embodiments of the present disclosure, the problem of heat generated in the busbar in a high current and fast charging environment can be solved by a novel type of busbar cooling structure. Additionally, the stability of the battery module can be improved by solving the heat generation problem.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is a perspective view of a part of a conventional battery module;

FIG. 2 is an enlarged a cross-sectional view along the xy plane at line A-A′ of FIG. 1;

FIG. 3 is an exploded perspective view of a battery module according to an embodiment of the present disclosure;

FIG. 4 is a perspective view showing the battery module of FIG. 3 when the components are combined;

FIG. 5 is a perspective view of one battery cell included in the battery cell stack of FIG. 3;

FIG. 6 is an enlarged cross-sectional view along the xy plane at line B-B′ of FIG. 4;

FIG. 7 illustrates the upper cross-section in FIG. 6 as viewed from above;

FIG. 8 is an enlarged cross-sectional view along the xz plane at line C-C′ of FIG. 4; and

FIG. 9 is an exploded perspective view of a part of a battery module according to another embodiment of the present disclosure.

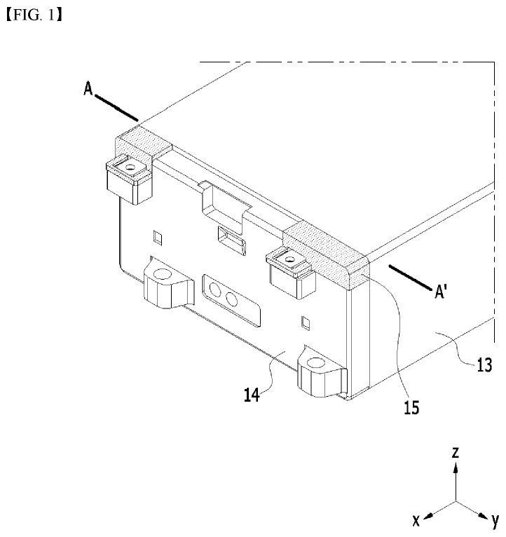

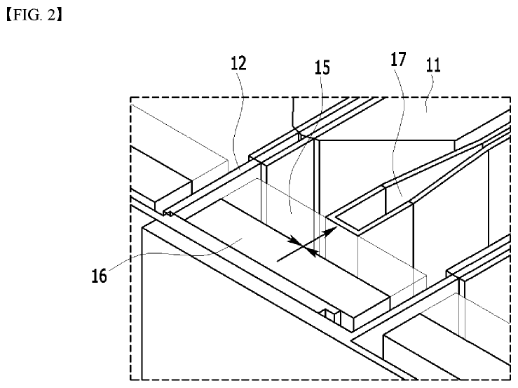

### DETAILED DESCRIPTION

Hereinafter, various embodiments of the present disclosure will be described in detail with reference to the accompanying drawings so that those skilled in the art can easily carry out these various embodiments. The present disclosure can be modified in various different ways, and is not limited to the embodiments set forth herein.

A description of parts not related to the description will be omitted herein for clarity, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of some layers and regions are exaggerated.

In addition, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, the word “on” or “above” means disposed on or below a reference portion, and does not necessarily mean being disposed “on” or “above” the reference portion toward the opposite direction of gravity.

Further, throughout the specification, when a portion is referred to as “including” or “comprising” a certain component, it means that the portion can further include other components, without excluding the other components, unless otherwise stated.

Further, throughout the specification, when referred to as “planar”, it means when a target portion is viewed from the upper side, and when referred to as “cross-sectional”, it means when a target portion is viewed from the side of a vertical cross section.

The terms “first,” “second,” etc. are used to explain various components, but the components should not be limited by the terms. These terms are only used to distinguish one component from the other component.

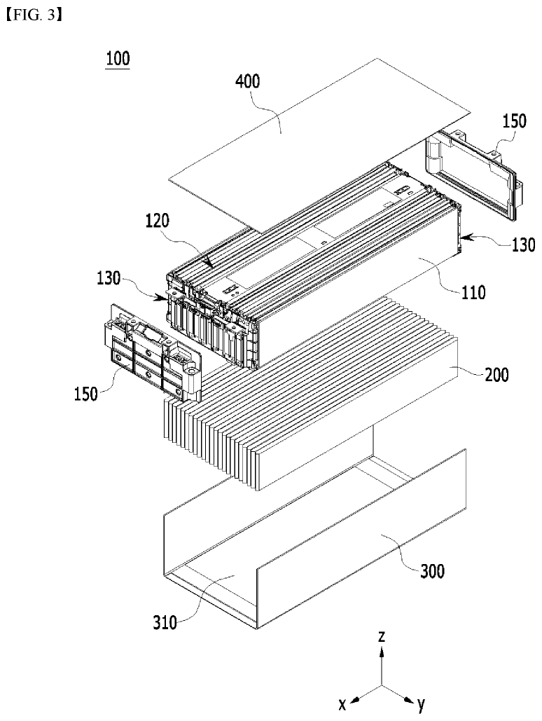

Now, a battery module according to an embodiment of the present disclosure will be described with reference to FIGS. 3 to 8.

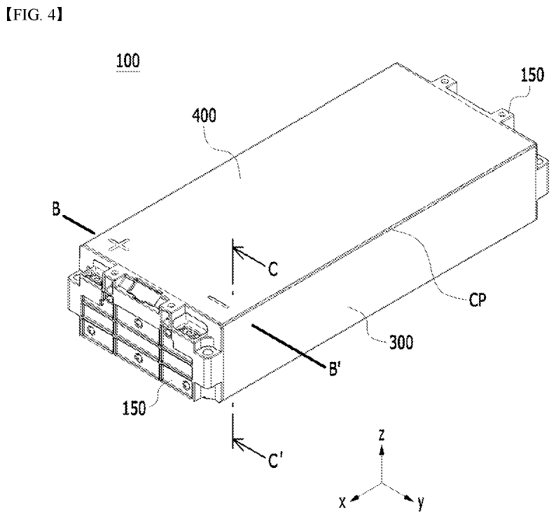

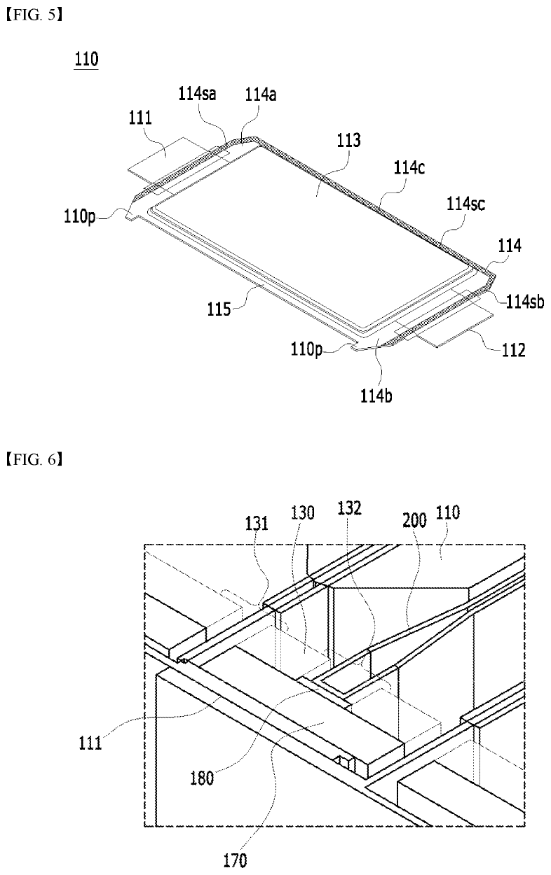

FIG. 3 is an exploded perspective view of a battery module according to an embodiment of the present disclosure. FIG. 4 is a perspective view of the battery module of FIG. 3 when the components of the battery module are combined. FIG. 5 is a perspective view of one battery cell included in the battery cell stack of FIG. 3.

As illustrated in FIGS. 3 and 4, the battery module 100 according to an embodiment of the present disclosure may include a battery cell stack 120 in which a plurality of battery cells 110 are stacked, a housing that houses the battery cell stack 120, an upper plate 400 that covers the upper surface of the battery cell stack 120, a pair of end plates 150, each of which are located on the front and rear surfaces of the battery cell stack 120, respectively, and a pair of busbar frames 130, each of which is located between the respective battery cell stack 120 and end plate 150. The housing may include a U-shaped frame 300 having an open upper surface, front surface and rear surface. Further, the battery module 100 includes a thermal conductive resin layer 310 located between the U-shaped frame 300 and the battery cell stack 120. The thermal conductive resin layer 310 is a heat dissipation layer, and may be formed by applying a material having a heat dissipation function. The pair of end plates 150 may be formed of a metal material.

When the open sides of the U-shaped frame 300 are referred to as a first side and a second side, respectively, the U-shaped frame 300 has a plate-shaped structure that is bent to continuously cover the front, lower and rear surfaces adjacent to each other among the remaining outer surfaces excluding surfaces of the battery cell stack 120 corresponding to the first side and the second side. The upper surface corresponding to the lower surface of the U-shaped frame 300 is open.

The upper plate 400 has a single plate-shaped structure that covers the remaining upper surface excluding the front, lower and rear surfaces which are wrapped by the U-shaped frame 300. The U-shaped frame 300 and the upper plate 400 can be coupled by welding or the like in a state in which the corresponding edge areas are in contact with each other, thereby forming a structure wrapping the battery cell stack 120. That is, the U-shaped frame 300 and the upper plate 400 can have a coupling part CP formed by a coupling method such as welding at an edge area corresponding to each other.

The battery cell stack 120 includes a plurality of battery cells 110 stacked in one direction, and the plurality of battery cells 110 may be stacked in the y-axis direction as shown in FIG. 3. In other words, a direction in which the plurality of battery cells 110 are stacked may be the same as a direction in which two side parts of the U-shaped frame 300 face each other.

The battery cell 110 is preferably a pouch type battery cell. For example, as illustrated in FIG. 5, the battery cell 110 according to the present embodiment may have a structure in which the two electrode leads 111 and 112 protrude from one end part 114a and the other end part 114b, respectively, of the battery main body 113 in mutually opposite directions. The battery cells 110 can be manufactured by joining both end parts 114a and 114b of the cell case 114 and both side surfaces 114c connecting them in a state in which an electrode assembly (not shown) is housed in the cell case 114. In other words, each of the battery cells 110 according to the present embodiment has a total of three sealing parts 114sa, 114sb and 114sc, wherein the sealing parts 114sa, 114sb and 114sc are sealed by a method such as heat fusion, and the remaining other side part may be formed of a connection part 115. Between both end parts 114a and 114b of the cell case 114 is defined as a longitudinal direction of the battery cell 110, and between the one side surface 114c and the connection part 115 that connect both end parts 114a and 114b of the cell case 114 is defined as a width direction of the battery cell 110.

The connection part 115 is a region that extends along a longer edge of the battery cell 110, and a protrusion part 110p of the battery cell 110 may be formed at an end part of the connection part 115. The protrusion part 110p may be formed on at least one of both end parts of the connection part 115 and may protrude in a direction perpendicular to the direction in which the connection part 115 extends. The protrusion part 110p may be located between one of the sealing parts 114sa and 114sb of both end parts 114a and 114b of the cell case 114, and the connection part 115.

The cell case 114 is generally formed of a laminated structure of a resin layer/metallic thin film layer/resin layer. For example, a surface of the cell case formed of an O (oriented)-nylon layer tends to slide easily by an external impact when a plurality of battery cells are stacked to form a medium- or large-sized battery module. Therefore, an adhesive member, for example, a sticky adhesive such as a double-sided tape or a chemical adhesive coupled by a chemical reaction upon adhesion, can be attached to the surface of the cell case to form the battery cell stack 120 and prevent sliding and maintain a stable stacked structure of the battery cells. In the present embodiment, the battery cell stack 120 may be stacked in a y-axis direction and housed in the U-shaped frame 300 in a z-axis direction. As a comparative example thereto, battery cells formed as cartridge-shaped components are used so that fixing between the battery cells leads to assembly of the battery cell stack in the battery housing. In this comparative example, there is almost no cooling action or the cooling may be proceeded in a surface direction of the battery cells, whereby the cooling does not well perform toward a height of the battery module, because of the presence of the cartridge-shaped components.

As illustrated in FIG. 3, the U-shaped frame 300 according to the present embodiment includes a bottom part and two side parts facing each other connected by the bottom part.

Before the battery cell stack 120 is mounted on the bottom part of the U-shaped frame 300, a thermal conductive resin is applied to the bottom part of the U-shaped frame 300, and the thermal conductive resin can be cured to form a thermal conductive resin layer 310. The thermal conductive resin layer 310 is located between the bottom part of the U-shaped frame 300 and the battery cell stack, and can serve to transfer heat generated in the battery cells 110 to the bottom of the battery module 100 and fix the battery cell stack 120.

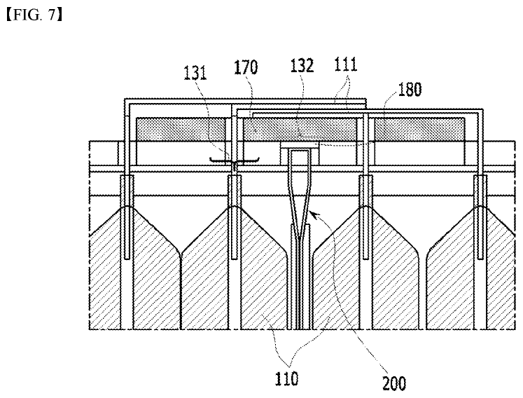

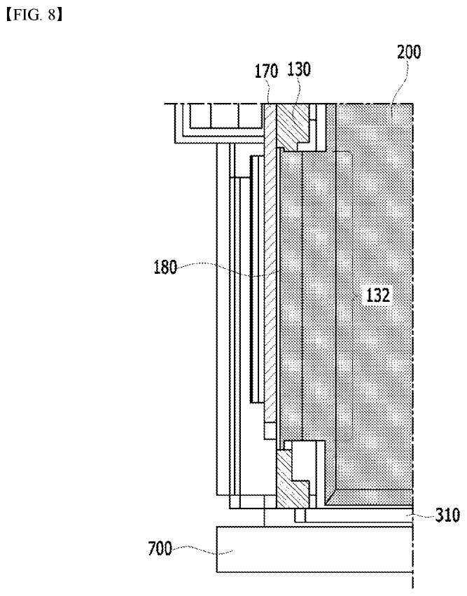

FIG. 6 is an enlarged cross-sectional view along the xy plane when viewed along line B-B′ of FIG. 4. FIG. 7 shows the upper cross-section in FIG. 6 as viewed from above. FIG. 8 is an enlarged view of a part of a cross-sectional view along the xz plane with reference to the line C-C′ of FIG. 4.

The conventional battery module does not have a direct cooling path for the busbar, and thus, heat generated by the busbar was emitted only by a path connecting to the busbar, electrode leads, battery cells, cooling fins, and thermal conductive resin layer. However, in a situation where high heat is generated at the busbar in a short time by the flow of high current, similarly to rapid charging, a cooling structure capable of minimizing the temperature rise of the busbar was needed.

Therefore, as illustrated in FIGS. 6 to 8, the battery module 100 according to the present embodiment includes a pair of busbar frames 130 covering a portion of the battery cell stack 120 exposed from the housing 300, a pair of busbars 170 connected to the electrode leads 111 protruding from the battery cell stack via a first slot 131 formed in the respective busbar frame 130, and a cooling fin 200 that is located between battery cells 110 adjacent to each other among the plurality of battery cells 110. The busbar 170 is connected to the cooling fin 200. Further, the battery module 100 according to the present embodiment may further include a heat transfer member 180 located between the respective busbar 170 and the cooling fin 200. In a modified embodiment, the heat transfer member 180 may be omitted, and the cooling fin 200 may be in direct contact with the respective busbar 170. The cooling fin is formed between the battery cells 110, and a plurality of cooling fins may be formed in the battery cell stack.

The busbar frame 130 according to the present embodiment may further include a second slot 132. The heat transfer member 180 may be formed to be adjacent to the second slot 132 of the busbar frame 130 to come into contact with the busbar 170. Also, the cooling fin 200 may be inserted into the second slot 132 to come into contact with the heat transfer member 180. Further, the cooling fin 200 may further come into contact with the second slot 132 and the busbar frame 130. Successive heat transfer of the busbar 170, heat transfer member 180 and cooling fin 200, or successive heat transfer of the busbar 170, heat transfer member 180, cooling fin 200 and busbar frame 130 can be made through these contacts.

The heat transfer member 180 according to the present embodiment may be formed of a material having electrical insulation properties and thermal conductivity. Specifically, the heat transfer member 180 may include one of a heat transfer pad and a thermal conductive resin layer. Therefore, the heat transfer member 180 may enable heat conduction while maintaining insulation properties between the respective busbar 170 and the cooling fin 200.

The heat transfer member 180 may be surface joined with the busbar 170, and the cooling fin 200 may be surface-joined with the heat transfer member 180. Therefore, heat in the busbar 170 may be transferred to the cooling fin 200 by the busbar 170, the heat transfer member 180, and the cooling fins 200 that are surface-joined as described above.

The battery module according to the present embodiment may further include a thermal conductive resin layer 310 that is located on the bottom part of the housing, particularly to the U-shaped frame 300 of the housing. The cooling fin 200 may come into contact with the thermal conductive resin layer 310. A cooling plate 700 may be included as a pack component or a cooling plate 700 may be integrally formed with the battery module under the bottom part of the U-shaped frame 300 included in the battery module according to the present embodiment. The heat transferred to the cooling fin 200 is transferred to the thermal conductive resin layer 310, and then transferred from the thermal conductive resin layer 310 to the cooling plate 700 to be discharged. Therefore, the heat generated from the busbar 170 may be sequentially transferred to the heat transfer member 180, the cooling fin 200, the thermal conductive resin layer 310, and the cooling plate 700 to be discharged. Through the sequential delivery and release structure as described above, heat from the busbar generated in a high current situation, such as rapid charging, can be effectively dissipated, and the stability of the battery module can be secured.

The cooling fin 200 according to the present embodiment can not only directly cool the busbar 170, but also transfer and cool the heat generated in the battery cell 110 to the thermal conductive resin layer 310 and the cooling plate 700, and thus, dual cooling of the battery module can be carried out. Further, the busbar 170 is thermally connected to the battery cell 110 having high specific heat and thermal capacity via the cooling fin 200, not only to slow down the temperature rise rate of the busbar 170, but also to lower the resistance of the busbar 170 by keeping the temperature of the busbar 170 rather high when the outside air temperature is low. Thereby, the energy efficiency can be increased.

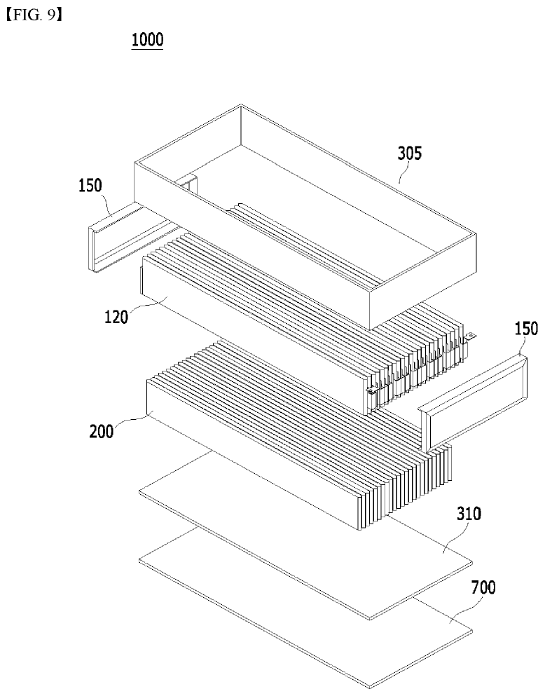

Next, a battery module according to another embodiment of the present disclosure will be described with reference to FIG. 9.

FIG. 9 is an exploded perspective view of a part of a battery module according to another embodiment of the present disclosure. Since contents overlapping with the contents of the above-mentioned battery module exist herein, only the contents different from those concerning the above-mentioned will be described.

As illustrated in FIG. 9, the housing of the present disclosure may be a wrapping frame 305 that is open at the upper and lower surfaces, and covers all side surfaces of the battery cell stack 120. Since the wrapping frame 305 is open at both the upper and lower surfaces, the thermal conductive resin layer 310 may be formed at a position corresponding to the lower surface of the wrapping frame 305. The battery module 1000 of the present disclosure includes a wrapping frame 305, whereby it can maximize the contact between the battery cell stack 120 and the thermal conductive resin layer 310 and between the cooling fin 200 and the thermal conductive resin layer 310 to maximize heat transfer and heat dissipation.

At this time, the battery module 1000 of the present disclosure may further include a cooling plate 700 that is located under the thermal conductive resin layer 310. The thermal conductive resin layer 310 may further come into contact with the cooling plate to conduct heat transfer. Accordingly, heat transfer can be maximized.

The above-mentioned battery module can be included in a battery pack. The battery pack may have a structure in which one or more of the battery modules according to the embodiment of the present disclosure are gathered, and packed together with a battery management system (BMS) and a cooling device that control and manage battery's temperature, voltage, etc.

The above-mentioned battery pack can be applied to various devices. Such a device may be applied to a vehicle means such as an electric bicycle, an electric vehicle, or a hybrid vehicle, but the present disclosure is not limited thereto, and is applicable to various devices that can use a battery module, which also falls under the scope of the present disclosure.

Although the invention has been shown and described with reference to the preferred embodiments, the scope of the present disclosure is not limited thereto, and numerous other modifications and embodiments can be devised by those skilled in the art, without departing from the spirit and scope of the principles of the invention described in the appended claims. Further, these modified embodiments should not be understood individually from the technical spirit or perspective of the present disclosure.

1. A battery module comprising:
a battery cell stack comprising a plurality of battery cells,
a housing for the battery cell stack,
a pair of busbar frames covering a portion of the battery cell stack not covered by the housing,
a pair of busbars, wherein each of the pair of busbars comprises a first slot, and each of the pair of busbars is connected to an electrode lead protruding from the battery cell stack via the first slot formed in the respective busbar frame, and
a cooling fin located between adjacent battery cells among the plurality of battery cells,
wherein each of the busbars is connected to the cooling fin.

2. The battery module of claim 1, further comprising:
a heat transfer member located between each of the pair of busbars and the cooling fin connected to respective busbar.

3. The battery module of claim 2, wherein:
each of the pair of busbar frames further comprises a second slot, and
the heat transfer member is located adjacent to the second slot and the heat transfer member is in contact with the respective busbar.

4. The battery module of claim 3, wherein:
the cooling fin is inserted into the second slot such that the cooling fin is in contact with the heat transfer member.

5. The battery module of claim 4, wherein:
the heat transfer member comprises a material having electrical insulating properties and thermal conductivity.

6. The battery module of claim 2, wherein:
the heat transfer member is surface joined with the pair of busbars.

7. The battery module of claim 6, wherein:
the cooling fin is surface-joined with the heat transfer member.

8. The battery module of claim 2, further comprising:
a thermal conductive resin layer located on a bottom part of the housing,
wherein the cooling fin is in contact with the thermal conductive resin layer, and the heat generated by the pair of busbars is sequentially transferred to the heat transfer member, the cooling fin, and the thermal conductive resin layer.

9. The battery module of claim 8, wherein:
the housing covers all side surfaces of the battery cell stack and does not cover upper and lower surfaces of the battery cell stack.

10. The battery module of claim 9, further comprising:
a cooling plate located under the thermal conductive resin layer,
wherein the thermal conductive resin layer is in contact with the cooling plate, and the thermal conductive resin layer transfers heat to the cooling plate.

11. A battery pack comprising the battery module of claim 1.
